(19) United States
(12) Patent Application Publication
(10) Pub. No.: US 2002/0182011 A1
(43) Pub. Date: Dec. 5, 2002

(54) Industrial waste disposal system

(76) Inventor: Jerry M. Brown, San Antonio, TX (US)

Correspondence Address: BAKER BOTTS, LLP, 910 LOUISIANA, HOUSTON, TX, 77002-4995, US

(21) Appl. No.: 10/157,507

(22) Filed: May 29, 2002

Related U.S. Application Data
(60) Provisional application No. 60/294,468, filed on May 30, 2001.

(51) Int. Cl. E02D 31/00; B65G 5/00; G21F 9/00; B09B 3/00

(52) U.S. Cl. 405/129.2; 405/129.25; 405/129.45

(57) ABSTRACT

A systematic method for disposing of industrial waste and increasing production of hydrocarbons from the earth is provided. The method may be used for increasing production of natural gas, natural gas liquids or crude oil. Waste streams from emitters of industrial waste, such as chemical plants, refineries, power plants and other installations are collected and processed to produce streams adapted for use in different types of hydrocarbon reservoirs. Gas streams are processed and injected into depleted or partially depleted gas or oil reservoirs, displacing natural gas that is produced from production wells. Liquid streams are processed and injected into depleted oil reservoirs or gas reservoirs after gas injection. Material that cannot be injected into a hydrocarbon reservoir is injected into a salt dome cavern.

This application claims the benefit of Provisional Patent Application 60/294,468, filed May 30, 2001.

### BACKGROUND OF THE INVENTION

1. Field of the Invention

This invention pertains to the disposal of gas, liquid, or solid waste. More particularly, methods are provided for operating a system to collect, transport, process and inject gaseous and liquid industrial waste materials into underground structures that may contain depleted or partially depleted oil and gas reservoirs.

2. Description of Related Art

Many areas of the United States and the world face critical environmental issues resulting from gas and liquid industrial emissions. Serious deterioration of the air and water quality in major cities and other areas of the country is occurring. A major contributor to this problem is emissions from refineries, chemical plants, power generation facilities, and other plants and industrial processes. Despite broad agreement as to the severity of the problem, there is no consensus how to solve it. The main thrust has been to attempt to substantially reduce or eliminate such emissions. Solutions are needed that recognize that it may be better to re-process the emissions for recovery of useful and commercial components and dispose of the offending waste, where possible, to increase the recovery of crude oil, natural gas or natural gas liquids.

The principal environmental problem arises from noxious industrial gas emissions, i.e. so-called “greenhouse” gases (carbon dioxide, sulfur dioxide, nitrogen oxides, etc.). In addition to the disposal of gases, the disposal of industrial liquid waste, contaminated plumes of organic or other liquid waste in fresh water aquifers, and other types of hazardous liquid waste material is also a significant problem. In many cases, incineration of waste materials may form dioxins or other unacceptable chemicals. Also, the disposal of hazardous solid waste is a continuing issue.

When natural gas reservoirs are “depleted”, it means there is insufficient pressure in the reservoir to allow the gas to flow to the surface under natural conditions and artificial methods are not economically justified. Normally, there is buildup of liquid hydrocarbons and/or water in the wells. This does not mean there is no gas left in the reservoir. On average, there will be 10% or more of the original gas remaining in the reservoir when it is abandoned. Thus, there are tens of trillions of cubic feet of natural gas left in so-called depleted gas reservoirs in the United States. As is the case with gas, much of the crude oil resource in the United States is not recovered by current oil field operating practices, leaving a target potential of tens of billions of barrels of oil. With some exceptions, the average range of oil recovery in the United States is 10-60% of the original oil-in-place at discovery. Many fields with large oil resources are abandoned after having recovered less than 20% of the oil originally in place. Across the United States at least 50% of the oil discovered will be abandoned (and lost forever) if economical improved recovery processes such as are being proposed here are not implemented.

U.S. Pat. No. 5,454,666 discloses disposal of carbon dioxide and other gases in coal seams. The capture and sequestration of carbon dioxide has been discussed in literature, for example, by Herzog (“CO₂ Capture and Sequestration: An Overview,” Proc. of AWMA Global Climate Change, Apr. 5-8, 1994). The availability of depleted oil and gas reservoirs in Texas has been considered for disposal of power plant carbon dioxide (“Disposal of Power Plant CO₂ in Depleted Oil and Gas Reservoirs in Texas,” Energy Convers. Mgmt Vol. 38, Suppl, pp. 211-216, 1997). A variety of industrial activities that can be used to decrease waste problems have been considered (“The Eco-industrial Park Model Reconsidered,” J. of Industrial Ecology Vol. 2, No. 3, pp. 8-10).

What is needed is the implementation of a variety of customized systems across the country that can be used to gather and dispose of a variety of waste emissions from a variety of sources in the most efficient manner. These wastes should either be processed to produce useful commercial products or disposed of in depleted or partially depleted oil and gas reservoirs where they contribute to increasing hydrocarbon recovery as a result of the disposal. Remaining materials that cannot be injected into a reservoir should preferably be disposed of in salt dome caverns.

### DESCRIPTION OF THE FIGURES

FIG. 1 shows an industrial waste disposal system having multiple sources of primarily gas emissions.

FIG. 2 shows injection of industrial emission gas into depleted or partially depleted gas reservoirs.

FIG. 3 shows an industrial waste disposal system having multiple sources of liquid waste.

FIG. 4 shows an industrial waste disposal system having multiple sources of solid and liquid waste.

FIG. 5 shows a map of the state of Kansas indicating the location of oil and gas wells.

FIG. 6 illustrates a disposal system disclosed herein that may be used in the state of Kansas.

### SUMMARY OF THE INVENTION

Use of a system to collect, process (i.e., separating components where appropriate), compress (gas) or pump (liquids), transport by pipeline to oil and gas fields and inject the emission gas or liquid waste into depleted or partially depleted oil and gas reservoirs through either new or existing injection wells is disclosed. Disposal of emission gas at low injection pressures into partially depleted gas reservoirs as a method to displace additional hydrocarbon gas, thus increasing recovery, is disclosed. Any material that cannot be injected may be disposed of in salt dome caverns in the earth.

The injection of offending industrial gas and water emissions into depleted and/or partially depleted oil and gas reservoirs will not only address environmental emission/disposal issues but will re-pressure and displace hydrocarbons from these reservoirs. The reservoir may be in any type of rock structure that can contain a hydrocarbon gas, oil or natural gas liquids. Either re-pressuring or displacement may result in increased gas and oil or liquid hydrocarbon recovery. Disposal of carbon dioxide (a by-product of processing some emission gases) in partially depleted rich gas reservoirs at high pressure can re-vaporize the heavier hydrocarbons that have liquefied in the reservoir as the reservoir pressure dropped. It is disclosed that the vapor and abandoned gas can then be recovered. It is also disclosed that optimal use of a depleted or a partially depleted natural gas reservoir scheduled for liquid waste injection may be obtained by injecting emission gas first to recover the hydrocarbon gas left in the reservoir and then filling the reservoir with the liquid waste. The combination of collecting, processing, transporting and injecting steps is selected for maximum economic benefit.

It is also disclosed that injection of other customized substances along with the emission gas or waste water into oil and gas reservoirs with temperatures in the range of 150-325° F. (depending on the depth of the reservoir) may either neutralize the waste material or create useful commercial materials when left at those conditions for many years or decades.

The disposal of those liquid and solid waste products from waste collection systems that cannot be disposed of in oil and gas reservoirs into new or existing salt domes in the earth is also disclosed. This combination of disposal systems addresses the disposition of all waste materials, whether in gaseous, liquid, sludge or solid form.

### DESCRIPTION OF PREFERRED EMBODIMENTS

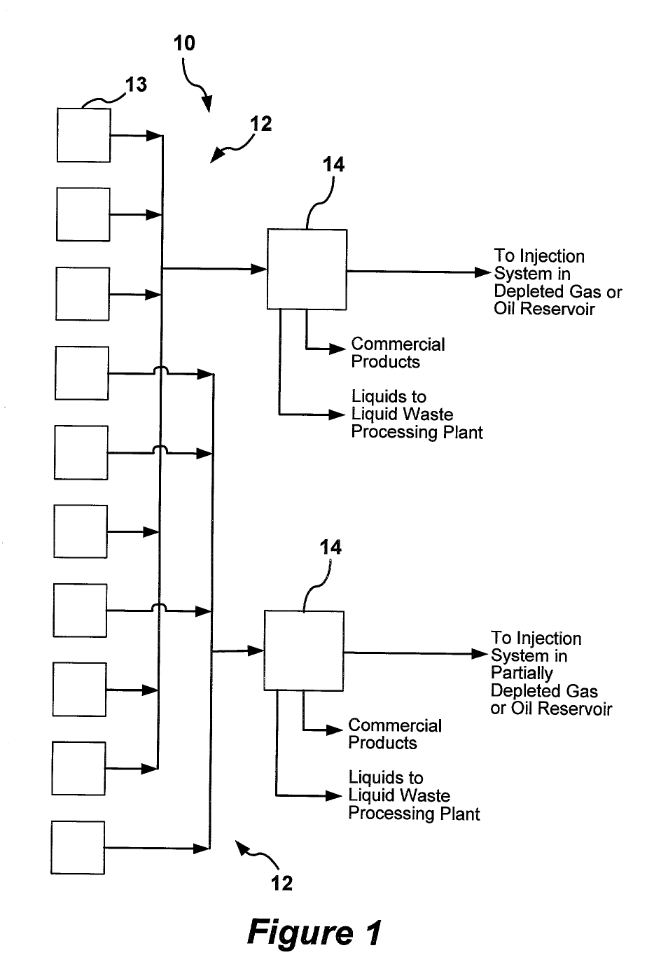

Referring to FIG. 1, industrial waste disposal system 10 for multiple sources of offending gaseous emissions is illustrated. System 10 includes industrial gas collection systems 12, collecting emissions from a variety of plants 13, which may include refineries, chemical plants, power generating plants and other facilities. Each collection system leads to processing/compression plant 14, where commercial products and liquid waste are separated. The gas remaining is then transported through a pipeline for injection into depleted or partially depleted gas or oil reservoirs.

The design, construction and installation of industrial waste disposal system 10 for offending industrial gas emissions should consider several factors. These include location of emission sources, distance from oil and gas reservoirs where the gas will be injected, number and type of emitters, and composition and volume of each emission source, both currently and in the future. The volume of emissions, composition of the various emission sources and location of sources may require more than one collection system in a single geographic area. Each gas system will require a customized design based on the volume and composition of the inlet emission gas and the products to be recovered. In order to optimize the processing of the emission gases and the potential to recover commercially valuable chemical or hydrocarbon products such as fertilizer (which may be urea) or pure products such as carbon dioxide and nitrogen, multiple processing plants or types of processes may be employed using known industrial techniques. Waste gas processing facility 14 may include compression, separation, (for example cryogenic processing, membrane technology, fractionation), storage facilities, and other processes and technologies.

Compression design for the volume of emission gas destined for disposal will depend on the location, volumes, and composition of the gases coming from the process plant(s) to be injected into oil and gas reservoirs, the distance to the oil and gas reservoirs to be utilized for disposal, the pressure of the reservoir into which the emission gas will be injected, and the reservoir pressure to be maintained while displacing the natural gas with emission gas to gas producing wells.

Transportation system (usually pipeline) design will depend on the volume of gas emissions being handled at each location, the composition of the gas streams, the distance to the oil and gas reservoirs to be used for disposal of the gas stream or streams, and the desired operating pressure of the pipeline.

Injection system design will depend on the volume of the gas to be injected, the number of injection wells to be utilized, the injection well pattern, and the injection pressure required to inject the gas. It is anticipated that in most cases existing wells will be utilized, but additional compression may ultimately be required due to increasing pressure in the oil or gas reservoir as it is re-pressured. As a safety precaution, the use of separation and filtration equipment should be used to prevent solid or liquid material originating from gas processing facility 14 from being injected into and plugging injection wells. The maximum ultimate injection pressure for each reservoir must be determined in the planning and design phase of the project.

In its simplest form, system 10 may include a single offending plant or small geographic area. Depending on the composition of the emission gas, it may be collected, compressed, transported, and injected without complicated processing. An analysis should be made, using known commercial methods, to determine if removal of products from the emission gas stream is commercially feasible.

A multiple collection system such as shown in FIG. 1 may be suitably located in an industrial area such as that around Houston, Texas, because (1) a large volume of emission gas is produced, (2) there are a large number of sources of emissions, and (3) the potential exists for grouping emissions from common industries. The main advantages of recovering commercial products are to provide income to defray capital and operating costs, reduce the total volume of emissions requiring disposal, and substantially increase the recovery of oil and hydrocarbon liquids, particularly if carbon dioxide is one of the products recovered. Other locations may have different system configurations and can be designed on a customized basis to fit the situation. For example, in locations like West Texas or South Louisiana there may be a trunk system that runs though the major oil and gas fields with various emitters tied into the system and processing plants located for maximum efficiency. The emission gas from a Louisiana or Texas processing plant may be sent to either onshore or offshore fields. In places like New Mexico or Oklahoma, where there is not a concentration of emitters, each state may have an extensive emission collection system that can collect emissions from major power generating plants across the state and from adjoining states. A gas system may customize the outlet streams from its processing plant to meet the requirements of the destination fields. For example, carbon dioxide is preferred for many West Texas oil reservoirs while some gas-prone areas would not benefit as much from carbon dioxide. An example considering a gas reservoir in the state of Kansas is described below.

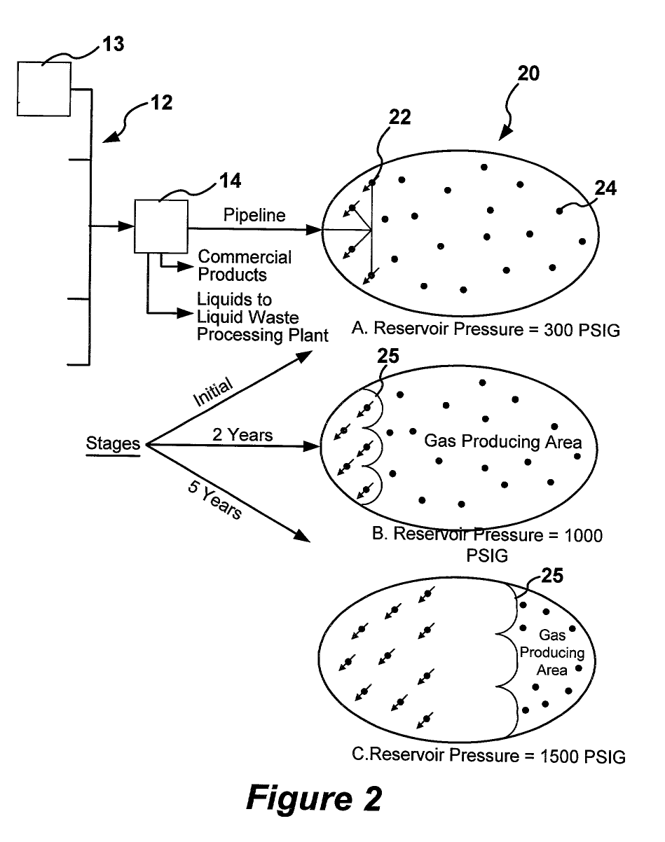

Referring to FIG. 2, injection of industrial emission gas into a depleted or partially depleted gas reservoir is illustrated. Crude oil or natural gas liquids may also be present in the reservoir, usually characterized by low reservoir pressure. These types of reservoirs exist throughout the United States and many other countries, and injection may be in progress in multiple reservoirs simultaneously. Emission sources 13 provide gas to collection system 12, from which the gas flows to processing/compression plant 14, where liquids and commercial products may be separated from the gas. The compressed gas is then transported by pipeline to depleted or partially depleted gas reservoir 20, having injection wells 22 and production wells 24. Initially, in condition A, pressure in reservoir 20 may be 300 psig. Original pressure may have been much higher. In condition B, which may be 2 years later, for example, gas injection has increased average reservoir pressure to 1000 psig and mixing zone 25 between injected gas and original gas has moved into the reservoir. An injection gas area forms around injection wells. In condition C, which may be 5 years after injection began, for example, reservoir pressure has been increased to 1500 psig and mixing zone 25 has moved through a large fraction of the reservoir. Wells that were originally producing wells 24 have been shut-in to avoid excess production of injected gas and additional injection wells 25 have been added. The injected gas will increase gas recovery from the reservoir by displacing residual gas present when injection begins. Injection of gas may also increase oil and other hydrocarbon liquid recovery from the reservoir by displacement of liquid or vaporization of liquid into the moving gas phase. The increase in pressure with time assumes that gas is produced at a lower rate than the injection rate. This process may continue until the emission gas virtually fills the reservoir and all recoverable hydrocarbon gas has been produced and sold. Emission gas injection may continue until the reservoir pressure reaches a selected pressure less than or equal to the reservoir pressure before production began from the reservoir. After all of the economically recoverable natural gas has been produced, all the producing wells would be shut-in, with the emission gas being stored in the underground reservoir and the reservoir abandoned. One or more wells may be retained as observation or test wells. Preferably, injection and production rates are selected to achieve an optimum range of reservoir pressure such that producing wells operate efficiently, i.e., without excess lifting cost of liquids accumulating in the wells, and reservoir displacement of hydrocarbons is maximized. This optimum range of reservoir pressure would be less than one-half of the original pressure of the reservoir.

The actual injection pattern chosen will depend on a number of the characteristics of the reservoir such as: depth, geographic size, structural relief, thickness, porosity, permeability, and density of the gas in the reservoir versus the density of the injected emission gas. Through the injection of the emission gas into depleted an/or partially depleted gas reservoirs, significant volumes of currently unrecoverable hydrocarbon gas and liquids will be recovered.

The injection of emission gas into depleted and/or partially depleted oil reservoirs will also have a positive effect on oil recovery in these reservoirs that have low bottom hole or reservoir pressure. Prior to the injection of emission gas from any source or sources, compositional tests should be conducted on the gas and solubility tests conducted on the oil using the emission gas to determine how much of the emission gas would be absorbed in the crude oil at increasing pressures at the prevailing reservoir temperature. Since maximizing ultimate recovery of oil is one of the goals of the industrial waste disposal system process, the emission gas should be tested with crude oil from several candidate oil fields during the planning and design phase to try and match a certain emission gas to the oil reservoir which will achieve the highest value of additional oil recovery.

The use of pure carbon dioxide is preferable as an injection gas for enhanced oil recovery in view of the fact that carbon dioxide is miscible with many crude oils at certain pressures and temperatures. For this reason, the recovery of carbon dioxide from the gas system processing plants is important. The availability of an inexpensive source of carbon dioxide can put this product in demand for use in many active oil fields throughout the world. Carbon dioxide can be used to increase reservoir pressure to that required to achieve miscibility. Carbon dioxide is actively being used in tertiary enhanced recovery in oil fields covering a very large area in West Texas. In these fields the carbon dioxide is sourced from naturally occurring, virtually pure carbon dioxide reservoirs in Colorado and New Mexico with limited remaining reserves. The carbon dioxide that is produced is recycled and injected back into the oil reservoirs to significantly increase oil recovery.

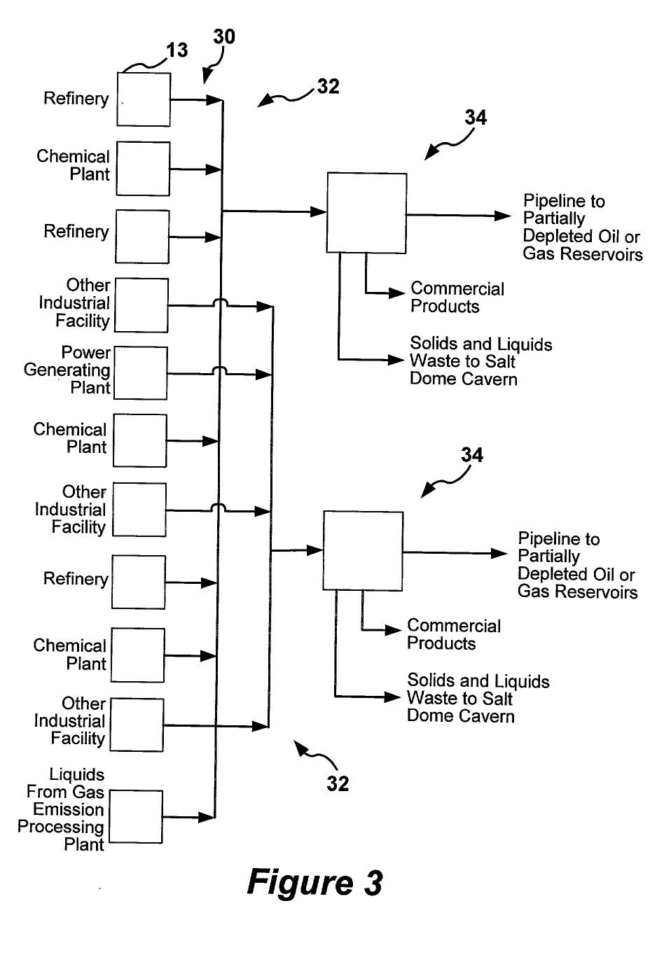

Referring to FIG. 3, industrial waste disposal system 30 for multiple sources of liquid waste emissions is illustrated. The planning, design, construction and installation of an industrial waste disposal system for offending liquid waste emissions must consider several factors. These include location of emission sources(s) 13, distance from oil and gas reservoirs where the liquid waste will be injected; number and type of emitters; and composition and volume of each emission source when the system is designed and in the future.

Depending on the volume of the waste liquid emissions, composition of the various emissions sources, location of sources, etc., more than one liquid waste collection system 32 may be required in a geographic area. Each liquids system will require a customized design based on the volume and composition of the inlet waste liquids and the type of products to be recovered. In some cases, the same pipeline may be used to transport both gas and liquid industrial waste material.

In order to optimize the processing of the liquid waste streams as well as handle the anticipated large incoming volumes, customized multiple processing plants and pumping stations 34 may be required. The processing facilities will likely recover products such as relatively clean water for injection in the oil and gas reservoirs, sludge for disposal in salt caverns or other cavities in the earth, and some liquids such as hydrocarbons or chemical products that may be returned as feedstock to one or more of emitters 13. The liquid waste processing facility may require breaking of emulsions, separation such as by high-temperature distillation, centrifuges, storage facilities, and other processes and technologies. The design of the pumping facilities will depend on the volumes and types of fluid to be injected, the distance to the oil and gas reservoirs to be utilized for disposal, and the depth and pressure of the reservoir into which the liquids will be injected.

The number of wells required in each reservoir for injection will be determined by the volume, composition, and quality of the fluid to be injected, the injection well pattern, and the injection pressure required to inject the fluid. An injection liquid zone will form around liquid injection wells. It is anticipated that in most cases existing wells will be utilized, but additional pumping equipment will ultimately be required due to increasing pressure in the oil or gas reservoir as it is re-pressured. Also, filtration equipment may be required to prevent plugging of the injection wells with solids or sludge material.

As was the case for the gas system, there is a wide range of application for offending liquid waste emissions in a separate system and into depleted or partially depleted oil and gas reservoirs. The unusable liquid by-products from plant processes, such as waste water, liquid products from drain systems, plumes of organic or other waste material in ground water, as well as other liquid waste may be injected into wells in depleted or partially depleted reservoirs. The liquid waste should be processed and filtered to remove any solids or thick organic materials prior to injection. It may be necessary or desirable to remove or segregate some of the liquid hydrocarbon material in order to recover commercial or re-processable products from the liquid waste inlet stream.

The liquids system may serve only one facility or small geographic area where the waste streams require only minimal processing prior to injection into the oil and/or gas reservoirs. The system may involve only collection, separation, filtration, transportation, and sufficient pumping equipment to inject the fluids into the oil or gas reservoir.

The economies of scale in a multi-industry location offer the greatest opportunity to positively impact the environment. The issues and challenges facing an area with multiple plants over a large or even small geographic area with diverse liquid waste emissions is similar to that discussed above in reference to the gas system. Such a situation will probably require multiple liquid waste collection systems due to: (1) the large volume of liquid waste emissions involved; (2) the large number of emission sources; and (3) the probability of similar discharges (containing hydrocarbons or chemical products) from refineries and some chemical plants being collected in one system for more efficient processing of the liquid waste stream and recovery of commercial products while other liquid discharges would be collected in another system or systems.

The processed fluids discharged from the liquid waste processing plants may be injected into depleted or partially depleted oil or gas reservoirs. The maximum recovery of hydrocarbon gas from a depleted or partially depleted gas reservoir scheduled for waste liquid injection can be obtained by injecting emission gas first. This is due to the better displacement efficiency of gas by gas. After the recovery of the hydrocarbon gas reaches an economic limit (caused by the presence of increasing percentages of emission gas in the producing wells) the gas producing wells may be shut-in and the injection of waste water for disposal and ultimate abandonment can commence. This should be a more efficient process resulting in higher recovery of the hydrocarbon gas than injection of waste water only. It is also expected that some increase in oil recovery will result from the liquids being injected into an oil reservoir. The decisions relating to which wastes should go to which reservoir should consider not only the total system cost but should include maximizing oil and gas recovery and the economic value of these products.

Those liquid and solid materials recovered in the gas and liquids systems that cannot be injected into oil and gas reservoirs, (due to plugging of the reservoir rock, for example) may be placed in salt dome caverns. There are numerous salt domes in Texas and Louisiana along the coast of the Gulf of Mexico, both onshore and offshore. Salt domes are located in other areas of the world. The Gulf Coast salt domes have been used for many years to store hydrocarbon materials, including crude oil, natural gas liquids (NGLs) and natural gas. The United States' Strategic Petroleum Reserves, totaling several hundred million barrels of oil, are currently stored in such salt dome caverns and the methods for forming and operating such storage facilities are well established.

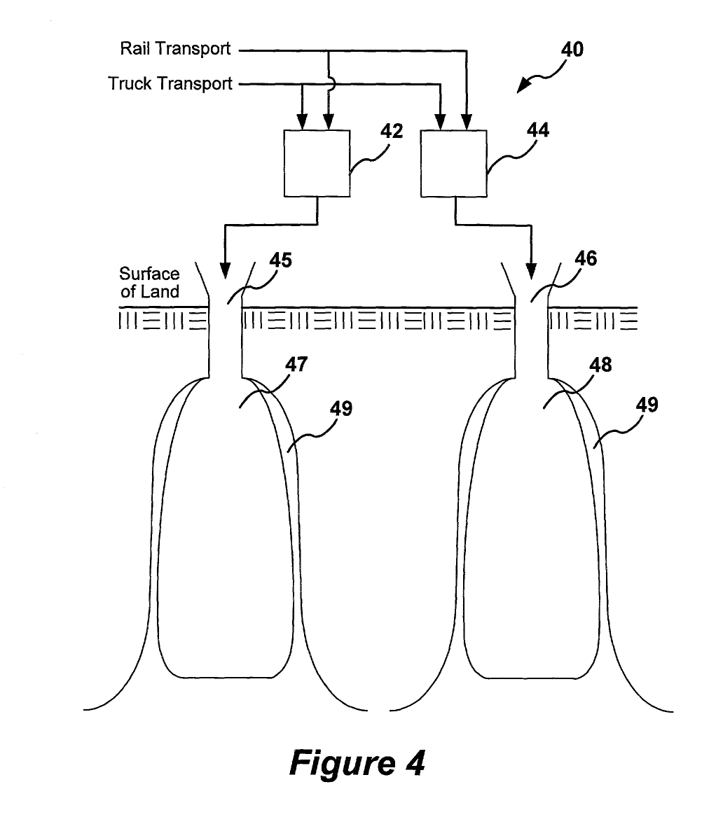

Unlike the processed gas and liquid waste from the gas and liquids systems, which are transported by pipeline to the oil and gas fields, the solid and liquid material destined for cavities such as salt dome caverns may require hauling by truck or rail. A schematic drawing of salt dome system 40 for the disposal of solid and liquid waste is shown in FIG. 4. Liquid handling and pumping system 42 and solid handling and transport system 44 provide material to input wells 45 and 46 drilled into caverns 47 and 48. Caverns are formed using known techniques in salt domes 49. By having multiple disposal caverns in close proximity, using economies of scale for storage, handling and disposal processes, and having a good plan in place to operate, maintain and manage the disposal process, the cost can be minimized. Also, only those materials that require this kind of “last resort” disposal will be sent to the salt dome caverns.

If multiple salt dome caverns are utilized, there is an advantage of placing like kind waste materials in the same cavern. This would increase the control and monitoring aspect of the material in the cavern on a short and long term basis. Also, by placing all hydrocarbon and organic waste material in the same cavern, methane gas may be commercially recovered from that cavern as the gas is released due to the degradation process of these materials.

It is expected that liquids will be recovered in an emission gas processing plant where large collection systems are involved that include refineries and chemical plants. These liquids will be mostly hydrocarbon liquids resulting from some unexpected inlet fluids due to carry-over from some source plant processes, as well as the processes and compression utilized within the waste gas processing plant. These liquids will be analyzed and, based on their composition, may be: (1) returned to a refinery or chemical plant as feedstock; (2) further processed within the emission gas plant to make commercial products; or (3) sent to a liquid waste emissions plant for further processing and/or disposal with other liquids from that plant then injected into oil and gas reservoirs.

It is also expected that some of the heavier hydrocarbon liquids recovered in the liquid waste emission plant will not be suitable for injection in an oil and gas reservoir due to the probability of plugging the reservoir rock. These heavier hydrocarbons may be used as: fuel for power generation, heat generation in the process system, application of other processing technology to make commercial products, or returned to a refinery or chemical plant for feedstock. If these heavy hydrocarbons are burned for the generation of power, heat, or incinerated, the gas emissions can be sent to waste gas emissions plant 14 (FIG. 1) for processing and disposal. The emission gas and liquid waste plants should work together to optimize processes, share resources and utilities, and transfer liquids and gas products to each other for ultimate disposal.

The sludge or very heavy hydrocarbons or other waste liquids which would plug oil and gas reservoirs as well as any solids resulting from the gas and liquid emissions plants would be shipped by truck or rail to the salt dome cavern. In this manner, the loop is closed such that all of the material entering the gas and liquid emission plants is processed and disposed of as follows:

returned as feedstock to a refinery, chemical plant, or other industrial facility;

transformed into a commercial product;

disposed of in a depleted and/or partially depleted oil or gas reservoir; or

disposed of in a salt dome cavern.

Compositional changes in a stored waste product may occur in a reservoir or salt dome cavern. The waste may be naturally neutralized by a chemical reaction with reservoir rock. This may eliminate or reduce the noxious nature of the stored emissions. Other materials may be injected along with the waste, such as bacteria or some other gas or liquid product, to cause a compositional change to produce a useful material that may then be recovered from the reservoir or salt dome cavern.

### EXAMPLE

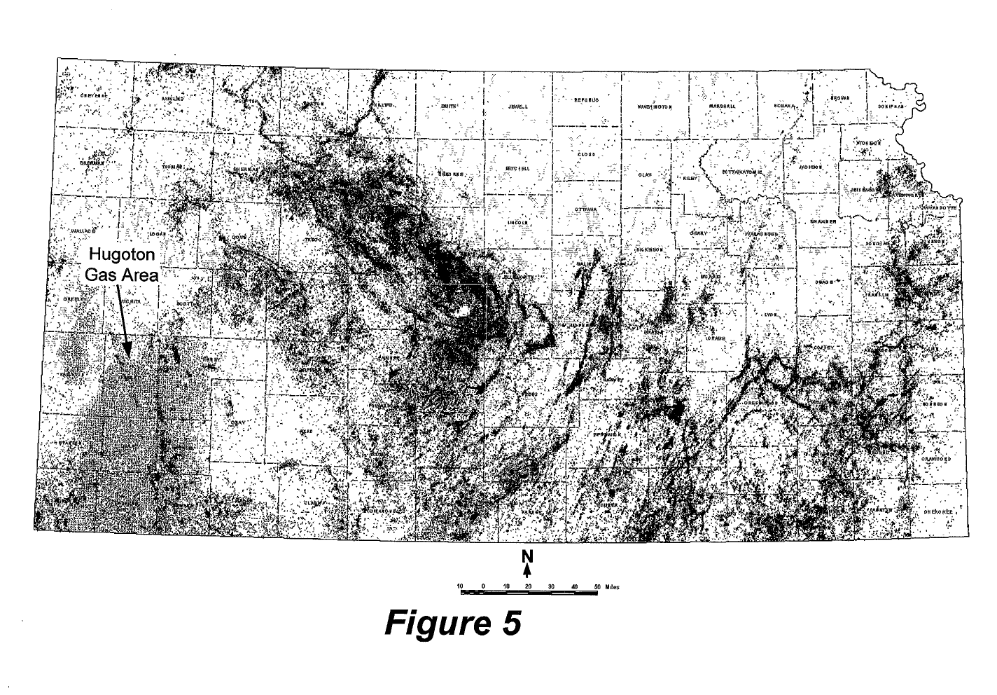

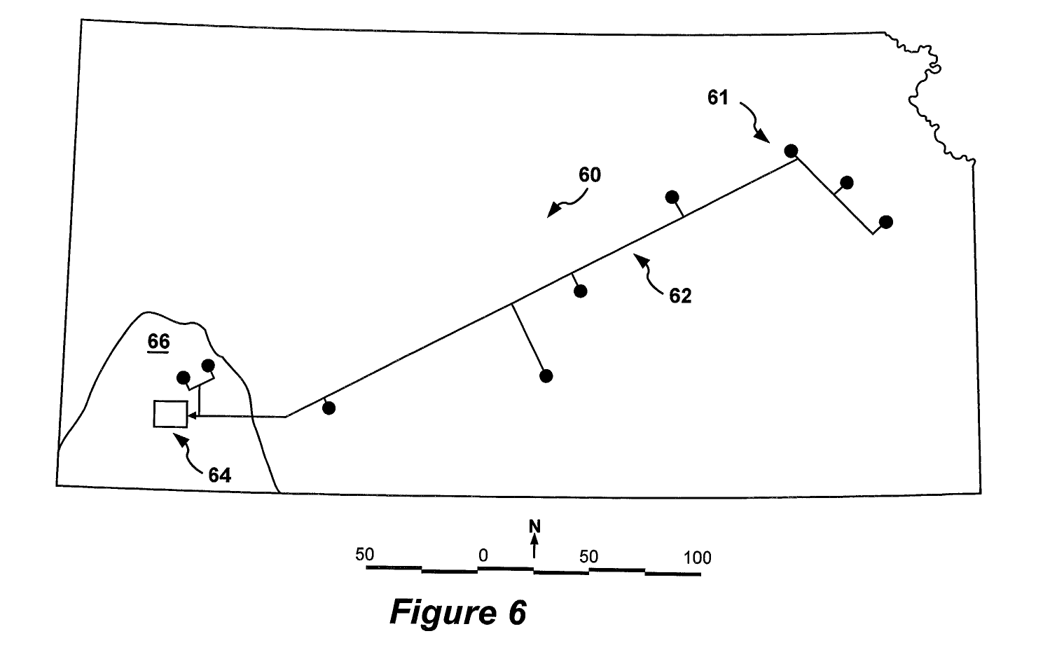

An example of the application of the disclosed methods is illustrated in FIG. 5 and FIG. 6. FIG. 5 shows a map of the state of Kansas with dots to indicate the location of wells. The map was provided by the Kansas Corporation Commission. The wells include active producing wells, abandoned wells, dry holes and injection wells. The total number of wells that have been drilled in Kansas numbers in the hundreds of thousands. The large area of wells in the southwest corner of the state is the huge Hugoton Gas Field, which has dimensions of about 80 miles by 90 miles.

The Hugoton field still has producing wells but reservoir pressure is very low. The volume of gas that will be abandoned in place in this reservoir is in the multi-trillions of cubic feet. The injection of emission gas to displace and recover natural gas from this reservoir, using the methods illustrated in FIG. 2 and discussed herein, will allow the recovery of substantial amounts of this gas.

FIG. 6 is a map of the state of Kansas showing industrial waste gas disposal system 60. Locations of sizable power generating plants 61 are shown, also provided by the Kansas Corporation Commission. The area of Hugoton gas field 66 is shown in the southwest corner of the state. A possible route of gas emission collection system 62 and a possible location of processing facility 64 in the Hugoton field are shown. Additional emission gas may be provided from emitters in surrounding states. Additional pipelines may be required.

The location of processing facility 64 depends on many factors, including the design of the field-wide emission gas distribution system, which may be installed in stages. In one embodiment, the emission gas processing plant cleans the emission gas by removing liquid or solids, compresses the gas and transports it to injection wells. Some gas may be used to produce urea or other chemicals. Nitrogen or carbon dioxide may be recovered for industrial use or for enhanced recovery in nearby oil reservoirs. The remaining gas may be placed in the injection gas distribution system for injection into the Hugoton reservoir.

Although the present invention has been described with respect to specific details, it is not intended that such details should be regarded as limitations upon the scope of the invention, except as and to the extent that they are included in the following claims.

What I claim is:

1. A method for disposal of industrial waste and recovery of natural gas, comprising:
collecting an industrial waste stream from an emitter of the industrial waste;
processing the industrial waste stream into a gas stream suitable for injection into a gas reservoir;
transporting the gas stream to a selected injection well penetrating a depleted or partially depleted gas reservoir and injecting the gas stream into the injection well; and
producing natural gas at a selected rate and time from a production well penetrating the depleted or partially depleted gas reservoir.

2. The method of claim 1 wherein the step of processing the industrial waste stream comprises application of separation technology.

3. The method of claim 1 further comprising collecting an industrial waste stream from a plurality of emitters before processing the industrial waste stream.

4. The method of claim 1 further comprising injecting the gas stream into a plurality of injection wells, the injection wells being selected to form an injection gas area in the reservoir.

5. The method of claim 1 wherein the step of producing natural gas from the reservoir at a selected rate and time is selected to increase pressure in the reservoir for a selected time during injecting the gas stream.

6. The method of claim 5 wherein the pressure in increased to a selected value for optimizing operation of production wells or reservoir displacement of natural gas.

7. The method of claim 1 further comprising the step of processing the industrial waste stream into a liquid stream and injecting the liquid stream after the step of injecting the gas stream.

8. The method of claim 7 wherein the liquid stream comprises a contaminated plume of organic or inorganic liquid waste from a ground water acquifer.

9. The method of claim 1 further comprising processing the industrial waste stream into a material that cannot be injected into a reservoir, transporting the material to a selected injection well penetrating a salt dome cavity in the earth and injecting the material into the salt dome cavity.

10. A method for disposal of an industrial waste and recovery of oil, comprising:
collecting an industrial waste stream from an emitter of the industrial waste;
processing the industrial waste stream into a gas or a liquid stream suitable for injection into an oil reservoir;
transporting the gas or the liquid stream to a selected injection well penetrating a depleted or partially depleted oil reservoir and injecting the gas or the liquid stream into the injection well; and
producing oil from a production well penetrating the depleted or partially depleted reservoir.

11. The method of claim 10 wherein the step of processing the liquid stream comprises separating a chemical product from the stream.

12. The method of claim 10 further comprising collecting an industrial waste stream from a plurality of emitters before processing the industrial waste stream.

13. The method of claim 10 further comprising injecting the gas or the liquid stream into a plurality of injection wells, the injection wells being selected to form an injection gas area or injection liquid area in the reservoir.

14. The method of claim 10 wherein the liquid stream comprises a contaminated plume of organic or inorganic liquid waste from a ground water acquifer.

15. The method of claim 10 further comprising processing the industrial waste stream into a material that cannot be injected into a reservoir, transporting the material to a selected injection well penetrating a salt dome cavern in the earth and injecting the material that cannot be injected into a reservoir into the salt dome cavern.

16. The method of claim 10 further comprising the step of injecting along with the waste stream a material selected to cause a compositional change in the waste stream.

17. The method of claim 15 further comprising the step of injecting along with the material that cannot be injected into a reservoir a material selected to cause a compositional change in the material that cannot be injected into a reservoir.

18. The method of claim 18 wherein the material selected to cause a compositional change is bacteria.
